(19) United States
(12) Patent Application Publication
(10) Pub. No.: US 2025/0250993 A1
(43) Pub. Date: Aug. 7, 2025

(54) STRUCTURAL DAMPING FOR SUBSEA NOISE MITIGATION

(71) Applicant: Chevron U.S.A. Inc., San Ramon, CA (US)

(72) Inventors: Peter F. Batho, Houston, TX (US); Grant Alistair Fraser, Stonehaven (GB)

(21) Appl. No.: 18/855,635

(22) PCT Filed: Apr. 14, 2023
(86) PCT No.: PCT/US2023/018705

§ 371 Date: Oct. 9, 2024

Related U.S. Application Data
(60) Provisional application No. 63/363,005, filed on Apr. 14, 2022.

(51) Int. Cl. F04D 29/66; E21B 43/36; F04D 29/60; F16F 15/08

(52) U.S. Cl. CPC F04D 29/669; F04D 29/605; F16F 15/08; E21B 43/36; F16F 2228/04

(57) ABSTRACT

Elastomeric dampers are used to mitigate noise associated with subsea oil and gas production processing equipment. A subsea oil and gas facility includes subsea equipment including one or more devices that generate vibrations during operation, one or more deepwater support structures providing one or more physical supports for the subsea equipment, and one or more elastomeric dampers configured to mitigate noise generated by the subsea oil and gas facility by attenuating vibrations between the one or more devices and the one or more deepwater support structures and/or by attenuating vibrations between the one or more deepwater support structures.

### CROSS-REFERENCE TO RELATED APPLICATIONS

This application claims priority to and the benefit of U.S. Provisional Application No. 63/363,005, filed Apr. 14, 2022 entitled “STRUCTURAL DAMPING FOR SUBSEA NOISE MITIGATION, which is hereby incorporated by reference herein for all purposes.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Subsea noise its sources and impacts are being increasingly scrutinized by non-governmental organizations and regulators. Noise emissions from shipping, defense and other operations and their consequences are being increasingly documented and understood. The development of subsea oil and gas facilities and resultant deployment of equipment on the seabed may generate long term noise that is transmissible over long distances. Accordingly, it is now recognized that a need exists for such long term noise to be mitigated.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In accordance with various aspects of this disclosure, subsea structural damping is used to mitigate noise associated with certain subsea equipment within subsea processing facilities, such as subsea pumping equipment or subsea compression equipment. For example, one or more elastomeric dampers configured for subsea use may be positioned at one or more structural interfaces supporting rotating equipment.

In accordance with an embodiment of this disclosure, a subsea oil and/or gas processing system includes rotating equipment located subsea and configured for subsea use. The rotating equipment comprising a pumping system and having one or more pumps, or a compression system having one or more compressors, or both, for processing oil and/or gas generated by the subsea oil and gas facility. At least one support structure is located on a seabed and supports the rotating equipment modules. The system includes one or more sets of elastomeric dampers or bushings configured for deepwater use and configured to mitigate noise generated by the subsea oil and gas facility by attenuating vibrations between the rotating equipment and their support structures.

In accordance with another embodiment of this disclosure, a method for attenuating noise in a subsea oil and gas facility includes installing a material that absorbs vibrations generated by the rotating machinery as a result of operating the oil and gas facility at one or more structural support interface locations of one or more structural supports located on a seabed, the material reducing or eliminating metal to metal contact at the structural support interface locations and thereby mitigating noise propagation from machinery through the station support structures.

### BRIEF DESCRIPTION OF THE DRAWINGS

The drawings illustrate only example embodiments and are therefore not to be considered limiting in scope, as the example embodiments may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles. In the drawings, reference numerals designate like or corresponding, but not necessarily identical, elements.

FIG. 1 is a block diagram of an example of an oil and/or gas system utilizing subsea equipment that has one or more elastomeric dampers at various interface locations, in accordance with an embodiment of this disclosure.

FIG. 2 is an example of the subsea compressor of FIG. 1 fitted with an elastomeric damper, in accordance with an embodiment of this disclosure.

### DETAILED DESCRIPTION OF THE INVENTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As set forth above, it is now recognized that it would be beneficial to mitigate noise generated by subsea production and processing equipment associated with oil and gas facilities. Vibration control measures are a recognized “best practice” to minimize vibration propagation and resultant noise for topside oil and gas rotating machinery. Subsea oil and gas facilities, however, provide a unique challenge due to the subsea operating environment and minimal opportunities for intervention over an extended operating life. To address noise mitigation in this environment, embodiments of this disclosure use elastomeric dampers or bushings (referred to hereinafter as “dampers” for the sake of brevity) in targeted locations associated with subsea oil and gas facilities. The noise mitigation/attenuation is done for targeted/applicable frequencies and at particular equipment locations (e.g., at interfaces between equipment and support structures, and/or between support structures) to reduce the acoustic profile of subsea processing facilities for long term deployment.

The noise mitigation techniques described herein may be associated with prior or concurrent installation of pumping and compression equipment where sound (e.g., low frequency sound, medium frequency sound, high frequency sound, or any combination) is produced. A specific example is the use of the disclosed noise mitigation techniques on a compression system and/or a pumping system deployed in subsea production facilities.

In a general sense, the present disclosure includes the use of elastomeric damping to mitigate certain types of noise (e.g., low frequency noise, medium frequency noise, high frequency noise, or any combination) produced by subsea oil and gas facilities.

The elastomeric dampers of this disclosure may have any appropriate shape and material construction that is suitable for reducing vibration and noise propagation of subsea machinery. As an example, the elastomeric dampers may reduce vibration and noise propagation from subsea machines through structural supports (e.g., structural steel) and to the seabed. The elastomeric dampers or bushings may be installed, for instance, between rotating machinery and their corresponding support structures in a subsea installation or between support structures of such an installation, or a combination. The elastomeric dampers may be used to mitigate noise associated with, for instance, deep-water pumping and compression equipment vibrations. This may be done by installing the elastomeric dampers at specific compressor or pump equipment locations in a manner that reduces metal-to-metal contact and vibration/noise propagation.

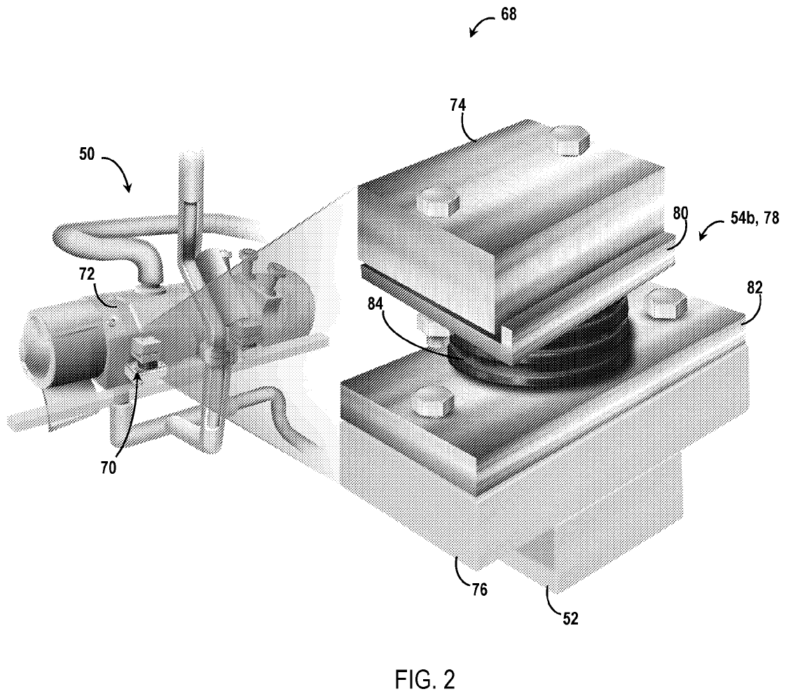

By way of non-limiting example, the elastomeric dampers may have any appropriate shape that accomplishes the vibration and/or noise mitigation desired for a particular location with the structure. As a specific example, the elastomeric dampers between machine and supports in their respective modules may have a conical shape, a toroidal shape, or any combination of these shapes or other simple or complex geometries (as shown in FIG. 2). In some embodiments, the elastomeric dampers or bushings may have a shape that allows fitment around at least a portion of a landing pin, a guide pin or post, a guide knife, or a receptacle of a subsea support structure. Further, in some embodiments, the elastomeric dampers or bushings may have a single-piece construction or a multi-piece construction as an elastomeric damper assembly. Such multi-piece construction may be desirable when various portions of the elastomeric dampers need to be designed to have differing degrees of hardness or flexibility to allow for secure fitment while also providing a desired degree of vibration and noise attenuation and long-term durability in a harsh marine environment.

The material construction of the elastomeric dampers may include one or more natural or synthetic elastomeric materials and one or more structural plates (e.g., steel plates) to assist load bearing properties and improve shear strength properties to ensure extended functional life. The elastomeric dampers may also be constructed from composites. For example, an elastomeric damper assembly may include only one elastomeric material or may include a combination of at least a first and a second elastomeric material or may include an elastomeric or steel laminate materials as a matrix material with an additive material to form a composite. The additive material may provide enhanced structural reinforcement, chemical stability, temperature stability, or a combination, to the elastomeric damper or bushing.

In some embodiments, the elastomeric dampers of this disclosure may have a design life sufficient to withstand decades of use in dynamic operation at a deepwater location (e.g., seabed location) without losing their vibration and noise damping properties due to degradation, for example as a result of shear stress. In one embodiment, the design life of the elastomeric dampers may be at least 20 years, at least 30 years for retrievable machinery modules, whereas for permanent structures at least 40 years, or at least 50 years or more is applicable. The design life may account for a combination of the load and dynamic shear stress to be applied to the elastomeric dampers, the temperature and pressure to be experienced by the elastomeric dampers, and the chemical environment to be experienced by the elastomeric dampers. In some embodiments, the elastomeric dampers may have a material construction that allows them to attenuate noise but to conduct heat to the surrounding environment (e.g., seawater) so as to avoid hot spots in the elastomeric dampers that may lead to uneven load distribution (e.g., due to thermally-induced material softening resulting from energy absorption). In one non-limiting example, the elastomeric dampers or bushings may have anisotropic thermal conductivity.

As the elastomeric dampers are configured to be used in a subsea installation, the elastomeric dampers may be configured to have a certain attenuation level for vibration and noise propagation (e.g., a designed noise mitigation level) between specific subsea components at a water depth of at least 100 meters, at least 500 meters, at least 1000 meters, at least 1250 meters, at least 1500 meters, at least 2000 meters, or at least 2500 meters; for example between 1000 meters and 1500 meters, or between 2000 meters and 3200 meters. The elastomeric dampers may be configured to attenuate vibration and noise propagation in a similar fashion (e.g., provide a designed noise mitigation level) at a “non-dynamic” e.g., fabrication, insulation and storage temperatures between −30° C. and 65° C. and an operational (“dynamic”) e.g., installed design temperature of 2° C. to 30° C. Such a temperature range may allow the elastomeric dampers to be pre-installed on certain types of equipment before final deployment at their ultimate subsea location. In one non-limiting embodiment, the elastomeric dampers or bushings may be configured to attenuate vibration and noise propagation at an operational (e.g., environmental) temperature of between 25° C. and 30° C. at an operational depth of between 100 m and 150 m for shallow water service with ambient light. In another non-limiting embodiment, the elastomeric dampers or bushings may be configured to attenuate vibration and noise propagation at an operational temperature of between 3° C. and 5° C. at an operational depth of between 1200 m and 1500 m with limited ambient light. In a further non-limiting embodiment, the elastomeric dampers or bushings may be configured to attenuate vibration and noise propagation at an operational temperature of between 3° C. and 5° C. at an operational depth of up to 3200 m with no ambient light.

As noted above, in a general sense, the elastomeric dampers of this disclosure may be used at various interfaces between rotating machinery and subsea structures. The interfaces may include those deemed to undergo the most vibration and/or noise propagation or generation that are directly supporting the machinery. In one example method, one or more studies of a subsea structure may be performed to determine the interfaces at which vibrations and noise may propagate at certain frequencies targeted for attenuation/mitigation. The predicted energy/power level (e.g., vibration or decibel level) at such interfaces may be determined to identify whether the interface is one where the elastomeric dampers would be beneficial for noise attenuation.

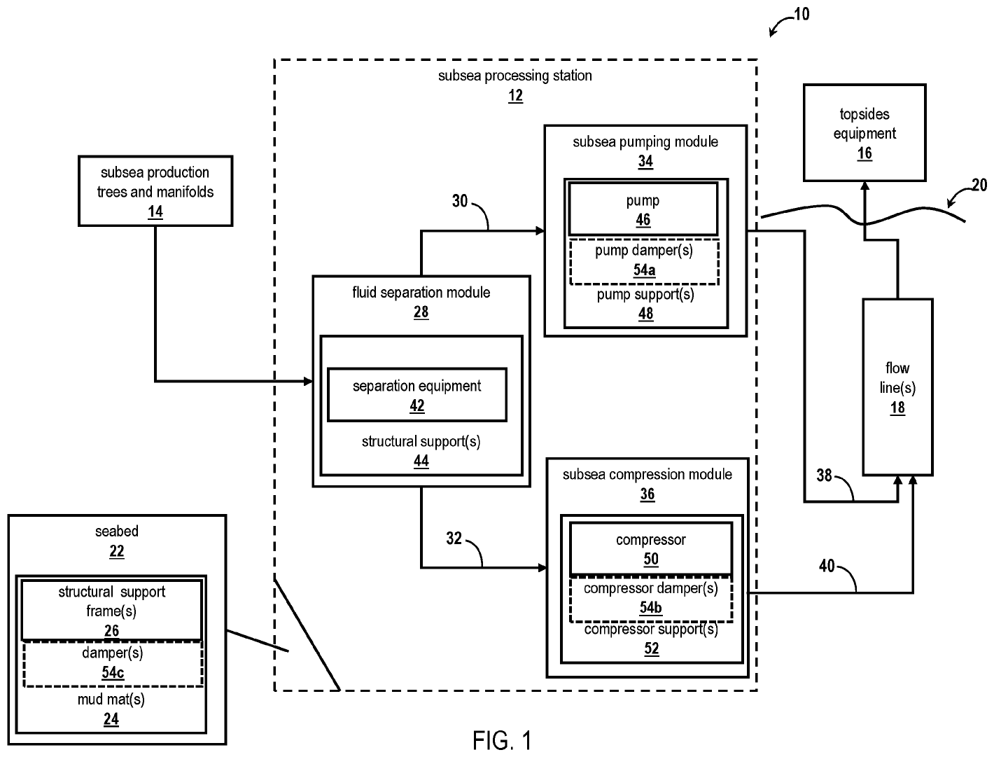

The embodiments of this disclosure may encompass a variety of configurations, an example of which is depicted in FIG. 1, which is a block diagram of an oil and/or gas production system 10 utilizing subsea equipment with noise mitigation features, all of which is configured for deepwater use. In the illustrated embodiment, the system 10 includes a subsea processing station 12 that processes production fluids (e.g., oil, gas, or a mixture thereof) received from subsea production trees and manifolds 14. The processed production fluids generated by the subsea processing station 12 are transmitted to topsides equipment 16 by one or more flow lines 18 that cross a water line 20 (e.g., a shoreline or to a topside facility). The topsides equipment 16 may include, by way of non-limiting example, a liquefied natural gas (LNG) plant, gathering and separation facility, a petroleum-fired power plant, or the like. The system 10 may also include certain features that are not shown, such as umbilicals and a local field control station (FCS) or other facility or structure above the waterline. Umbilicals may be used to transmit electrical power and/or signals, hydraulic power and/or signals, or both, between the subsea production trees and manifolds 14, the subsea processing station 12, or a combination, and the FCS or other topside facility.

The subsea processing station 12 as illustrated is positioned on the seabed 22 via one or more structures. Such structures may include one or more mud mats 24 and one or more structural frames 26; where in some embodiments the one or more mud mats 24 are positioned directly on the seabed 22, and the one or more structural frames 26 are positioned atop the one or more mud mats 24. The one or more structural frames 26 may each correspond to a particular section of the subsea processing station 12, such as to all or a part of a particular module as described herein. It should be noted that certain types of noise, when unmitigated, may be transmitted through the one or more mud mats 24 and/or the one or more structural frames 26, which will generally be of metallic construction.

As noted, the subsea processing station 12 may include one or more modules that process produced fluids, such as by separation, pumping, and/or compression. The illustrated subsea processing station 12 includes a fluid separation module 28 configured to separate produced fluids into its liquid components 30 and gaseous components 32, a subsea pumping module 34 configured to pump the liquid components 30 and a subsea compression module 36 configured to compress the gaseous components 32. Pressurized liquid 38 from the subsea pumping module 34 and compressed gas 40 from the subsea compression module 36 are transmitted through the flow lines 18 to the topsides equipment 16. Although not shown, in some embodiments there may be flowlines that recycle at least a portion of the pressurized liquid 38 and the compressed gas 40 back to the fluid separation module 28.

Each of the modules illustrated includes its respective components that process the produced fluids, and one or more structural supports that provide structural support for the equipment in the station 12. Specifically, the fluid separation module 28 includes separation equipment 42, which may be mounted on one or more structural supports 44; the subsea pumping module 34 includes one or more subsea pumps 46 mounted on one or more pump supports 48; and the subsea compression module 36 includes one or more subsea compressors 50 mounted on one or more compressor supports 52. The supports 44, 48, 52 may be physically connected (e.g., secured) to their individually deployable and retrievable modules to facilitate installation and periodic retrieval for maintenance. The modules are supported by one or more structural frames 26 and accordingly the one or more mud mats 24 to secure and support the mass of installed equipment. Thus, noise generated by vibrations originating from the operation of the rotating machinery in the modules—may be transmitted through a number of different structures of the station 12.

To mitigate at least some of the noise, the station 12 may include dampers 54 positioned in specific locations to reduce direct vibration and noise transmission. Various embodiments of the system 10 may utilize any one or a combination of the dampers 54 and damper locations described herein. The subsea pumping module 34 includes one or more pump dampers 54a located between the subsea pump 46 (e.g., the subsea pump housing) and the one or more pump supports 48. The subsea compression module 36 includes one or more compressor dampers 54b located between the subsea compressor 50 (e.g., the subsea compressor housing) and the one or more compressor supports 52.

In still further embodiments, to further attenuate noise propagation through the station 12 one or more dampers 54c may be positioned between one or more of the structural support frames 26 and the one or more mud mats 24. Example locations may include positioning the one or more dampers 54c about a guide knife, about a guide post or pin, and/or around a portion of a landing pad of the one or more mud mats 24.

Although not specifically illustrated, certain of the flow lines associated with the subsea compression station 12 may be adjacent to one another and may include features such as flow control valves, flow bends, process equipment (such as coolers or separators) and or other constrictions that cause their transmitted fluid to induce vibrations. In certain embodiments, dampers configured in accordance with this disclosure may be used to mitigate noise caused by such flow induced vibrations (FIV), such as by preventing or attenuating vibration and contact between adjacent components (e.g., adjacent flowlines and/or adjacent valves or other protrusions). The dampers may be positioned around at least a portion of adjacent flowlines, processing equipment and/or adjacent valves.

With particular reference to the subsea pumping module 34 and the subsea compression module 36, it should be noted that their active components (i.e., pump 46 and compressor 50, respectively) may be considered to be generally referred to as “rotating equipment.” In certain embodiments, it may be desirable to attenuate the noise that is specifically generated by operation of this equipment at source by implementing the dampers 54 at the machinery mounting points. FIG. 2 is a perspective view illustrating an embodiment of a subsea compressor assembly 68 where the one or more compressor dampers 54b are located at an interface 70 between the compressor 50 and the compressor support 52. The approach described for FIG. 2 is also applicable to a subsea pump assembly including the pump 46 and pump support 48.

As shown in the embodiment of FIG. 2, the compressor 50 includes a compressor housing 72, which surrounds the internal working equipment of the compressor 50. The compressor 50, including its internal equipment and its housing 72, are configured for deepwater use in accordance with the conditions described herein. As shown in the expanded portion of FIG. 2, a compressor attachment point 74 is connected to the compressor housing 72, and the compressor damper 54b is positioned between the compressor attachment point 74 and a support attachment point 76 of the compressor support structure 52.

As depicted in the illustrated embodiment, the compressor damper 54b (and other dampers described herein) may be of a multi-piece construction and may be referred to as a damper assembly 78. In other embodiments, the damper may be of a single-piece construction. The compressor damper assembly 78 as illustrated includes a first rigid section 80, a second rigid section 82, and a deformable/vibration absorbent section 84. Any one or a combination of these sections may be formed from an elastomer; however, in most embodiments only the deformable section 84 will include an elastomer while the first rigid section 80 and the second rigid section 82 are made from sturdy materials such as steel or another metal. The first and second rigid sections 82 are configured to form relatively rigid connections of the housing 72 and the compressor support structure 52, respectively, while the deformable section 84 has a material and shape configuration that is configured to attenuate vibrations and, thus, noise. The material and shape configuration may provide multi-dimensional freedom of movement by a predetermined amount (e.g., by a fraction of a millimeter), or may provide freedom of movement in a limited number of directions (e.g., via compression and expansion). In the illustrated embodiment, the deformable section 84 is made from a softer material than the first and second rigid sections 80, 82, and has a bellows-like shape.

With reference to the deformable section 84, the dampers may, in some embodiments, include at least one elastomeric damper or bushing that has a complex geometry and laminations of differing materials to achieve the required damping performance (i.e., a complex geometric shape that combines all or a portion of simple shapes). The complex geometry may be formed to correspond to a shape of a portion a structural support interface, a piece of equipment that generates noise, or to allow certain types of movement as noted above, or a combination.

The configuration of the damper 54b (damper assembly 78) may include shape, thickness, and material construction selected such that the damper 54b is configured to attenuate noise having particular frequencies, such as the portion of the spectrum corresponding to compressor noise. By way of non-limiting example, the damper 54b is configured to mitigate noise output from the compressor 50 in a range of between 600 Hz and 2500 Hz.

Regarding other configurations, the dampers 54 may be generally configured to attenuate noise having a frequency ranging from 5 Hz to 10,000 Hz, with particular subranges being selected to correspond to and target a desired noise source. By way of further non-limiting example, in some embodiments the one or more dampers 54 may be configured to mitigate noise output from one or more subsea pumps (e.g., pump 46) in a range of between 40 Hz and 700 Hz. Higher frequencies of noise may result from flow-induced vibrations such as vibrations caused by fluid flow through choke valves or other flow control valves, fluid flow through constrictions or bends, or the like.

In an embodiment, a method includes arranging and applying multiple dampers of a specific design (e.g., for high, medium, and/or low frequency) in the target locations in the subsea station (e.g., of a subsea oil and gas facility)—such as the structural support locations noted above.

It will be understood that various modifications may be made to the embodiments disclosed herein. Therefore, the above description should not be construed as limiting, but merely as exemplifications of example embodiments. For example, the functions described above and implemented as the best mode for operating the present invention are for illustration purposes only. Other arrangements and methods may be implemented by those skilled in the art without departing from the scope and spirit of this invention. Moreover, those skilled in the art will envision other modifications within the scope and spirit of the claims appended hereto.

1. A subsea oil and/or gas system comprising:
rotating equipment located subsea and configured for subsea use, the rotating equipment comprising a pumping system and having one or more pumps, or a compression system having one or more compressors, or both, for processing oil and/or gas generated by the subsea oil and gas facility;
at least one support structure located on a seabed and supporting the rotating equipment; and
one or more elastomeric dampers configured for deepwater use and configured to mitigate noise generated by the subsea oil and gas facility by attenuating vibrations between at least a portion of the rotating equipment and the at least one support structure.

2. The system of claim 1, wherein the one or more elastomeric dampers are configured to provide a designed noise mitigation level at a sea depth of at least 100 meters.

3. The system of claim 1, wherein the one or more elastomeric dampers are configured to provide a designed noise mitigation level in an underwater ambient temperature between 2 and 30° C.

4. The system of claim 1, wherein the one or more elastomeric dampers are configured to mitigate noise output from the one or more compressors in a range of between 600 Hz and 2500 Hz.

5. The system of claim 1, wherein the one or more elastomeric dampers are configured to mitigate noise output from one or more pumps, the noise having a range of between 40 Hz and 700 Hz.

6. The system of claim 1, wherein the one or more elastomeric dampers are configured to mitigate noise output from the support structure, the noise having a range of between 5 Hz and 10000 Hz.

7. The system of claim 1, wherein the one or more elastomeric dampers comprises an elastomeric damper positioned between a subsea compressor and a compressor support structure supporting the subsea compressor on the seabed.

8. The system of claim 1, wherein the one or more elastomeric dampers comprises a damper assembly, the damper assembly comprising a first rigid section, a second rigid section, and a deformable section connecting the first and second rigid sections, wherein the first rigid section is connected to an attachment point of the rotating equipment, and the second rigid section is connected to an attachment point of the support structure supporting the rotating equipment.

9. The system of claim 8, wherein the deformable section of the damper assembly comprises a complex geometry.

10. The system of claim 8, wherein the deformable section has a bellows shape.

11. The system of claim 8, wherein the deformable section is configured to expand and contract by a predetermined amount to mitigate vibrationally-induced noise generated by the rotating equipment.

12. A method for attenuating noise in a subsea oil and gas facility, comprising:
installing a material that absorbs vibrations generated as a result of operating the oil and gas facility at one or more structural support interface locations of one or more structural supports located on a seabed, the material reducing or eliminating metal to metal contact at the structural support interface locations and thereby mitigating noise propagation through the one or more structural supports.

13. The method of claim 12, wherein the material is a damper or bushing comprising a polymer.

14. A subsea oil and/or gas processing system comprising:
subsea equipment comprising one or more devices that generate vibrations during operation;
one or more deepwater support structures providing one or more physical supports for the subsea equipment; and
one or more elastomeric dampers configured to mitigate noise generated by the subsea oil and gas facility by attenuating vibrations between the one or more devices and the one or more deepwater support structures and/or by attenuating vibrations between the one or more deepwater support structures.
